(19) United States
(12) Patent Application Publication
(10) Pub. No.: US 2019/0077330 A1
(43) Pub. Date: Mar. 14, 2019

(54) REAR VEHICLE SEAT WITH STORAGE HOOP AND STRAP ATTACHMENT

(71) Applicant: ADIENT LUXEMBOURG HOLDING S.Á R.L., Luxembourg (LU)

(72) Inventors: Eric MICHALAK, Northville, MI (US); Brent BURTON, Windsor (CA); Mason PIKE, Howell, MI (US); Nathan CARUSS, Ann Arbor, MI (US); Alex SAVESKI, South Lyon, MI (US); Michael J. KAPUSKY, South Lyon, MI (US)

(21) Appl. No.: 16/190,499

(22) Filed: Nov. 14, 2018

Related U.S. Application Data
(63) Continuation-in-part of application No. 15/067,352, filed on Mar. 11, 2016, now Pat. No. 10,144,315.
(60) Provisional application No. 62/132,030, filed on Mar. 12, 2015.
(60) Provisional application No. 62/690,523, filed on Jun. 27, 2018.

(51) Int. Cl. B60R 11/00; B60N 2/30

(52) U.S. Cl. CPC B60R 11/00; B60N 2/3045; A47C 7/62; B60R 2011/0094; B60R 2011/0012

(57) ABSTRACT

A vehicle seat includes a backrest and a seat base as a seat part. The seat part includes a seat part frame, a trim side and an opposite harder side. The harder side has an outer peripheral surface with a recess contour. Fittings form a seat base to backrest pivot connection, for pivoting the seat base relative to the backrest and/or pivoting the backrest relative to the seat base. Pivotable hoop connections are connected to the vehicle seat frame adjacent to the opposite harder side. A storage hoop has hoop ends respectively connected to the respective pivotable hoop connections. The storage hoop is received in the recess in a stowed position, in which the hoop is disposed inwardly of a remainder of the outer peripheral surface. The stowed hoop may pivot out of the recess to a hoop deployed position, with the hoop extending outwardly from the opposite harder side.

### CROSS REFERENCE TO RELATED APPLICATIONS

This application claims the benefit of priority of U.S. Provisional Application 62/690,523, filed Jun. 27, 2018, the entire contents of which are incorporated herein by reference, and is a continuation in part of U.S. application Ser. No. 15/067,352, filed Mar. 11, 2016, which claims the benefit of priority of U.S. Provisional Application 62/132,030, filed Mar. 12, 2015, the entire contents of which are incorporated herein by reference.

### FIELD OF THE INVENTION

The present invention relates to a vehicle seat and more particularly to a rear vehicle seat or middle vehicle seat and a vehicle seat arrangement, particularly for a pickup truck or SUV.

### BACKGROUND OF THE INVENTION

Pickup trucks and vehicles with a cab having a rear wall may have a rear seat behind the seat row with the driver seat. The rear seat is close to or at the rear cab wall. This presents a trade-off with regard to storage space behind the front row of seats and the provision of seats for rear seat passengers. Although pickup trucks with additional seating in the cab, behind the front row of seats, may have an extended cab, the rear most seats occupy space that could otherwise be used for storing items.

Some pickup trucks have rear seat arrangements with a rear seat row having only limited room and storage space. To allow for a changeover between a seating arrangement and an arrangement which provides more storage space, the rear seats may be so-called stadium seats, that allow the seat base to be folded up to expose space under the seat base.

SUVs, station wagons and even sedans have rear most seats close to or at the rear storage space or trunk. In some cases, the rearmost seat is mounted with a pivot and a pivot fixture, such that the seat can be released from a locked position allowing a seat part to pivot forward. This can position the rear surface of the backrest (seatback) of the vehicle seat as a load floor. This forward pivoting of the backrest of the rear most seat provides an extension of the floor of the trunk or rear storage space.

Rearmost seats that separate a seating area from the rear storage space or trunk also can include a pass-through opening, also known as a ski pass. This allows a portion of the seat to move to provide an opening between the passenger area and the storage space, allowing large items to extend into the passenger area (such as skis).

Items placed in a trunk or rear storage space or near a rear seating area may move around during vehicle travel. With some items, this can present a problem. For example, grocery bags and the like can tip over such that items fall out of the bags and may move about the trunk or storage space.

### SUMMARY OF THE INVENTION

It is an object of the invention to provide a vehicle seat with a seat base and/or a backrest having a trim side and an opposite harder side with a planar surface with a recess having a recess contour and with a storage hoop that is received in the recess to extend along the recess contour, whereby the storage hoop pivots between a stowed position with the storage hoop extending along and within the recess to a hoop deployed position, with the hoop extending outwardly from the opposite harder side that defines the surface with the recess.

It is an object of the invention to provide a vehicle rear seating configuration which provides support for stored items, with a storage hoop connected to a vehicle seat part (e.g., seatback or seat base). The storage hoop advantageously extends essentially horizontally forwards or backwards (with respect to a direction of travel), from the vehicle seat part, so to be used to maintain a position of stored items with respect to the vehicle. The storage hoop does not interfere with functions of the vehicle seat with the storage hoop in a stowed position.

A vehicle seat part, vehicle seat and vehicle rear seating configuration may advantageously provide support for stored items with the vehicle seat bottom in a stadium flipped up position and also provide support for items hung under the seat in a seated position.

A vehicle seat part, vehicle seat and vehicle rear seating configuration may advantageously provide support for stored items in a rear storage area or trunk space which is at least partially delimited by a back panel (hardback) of a backrest of a rearmost seat.

It is a further object of the invention to provide a rearmost seat with a structure which may be used to secure items but which otherwise does not interfere with the back panel of the rearmost seat, when the back panel is positioned as a load floor and functions as a load floor.

According to the invention, a vehicle seat is provided comprising a backrest (also known as a seatback) and a seat base (also known as a cushion) connected to the backrest. At least one of the backrest and the seat base comprises a trim side and a harder side. In particular, at a front side a seat part, namely a seat part frame (seat base frame or backrest frame) supports, at an occupant engaging surface, foam covered by trim. The opposite harder side has a planar (essentially planar in most portions thereof) surface with a recess having a recess contour. Fittings provide a seat base to backrest pivot connection, which is provided between the backrest and the seat base, for pivoting the seat base relative to the backrest or pivoting the backrest relative to the seat base. Pivotable hoop connections are pivotably mounted at the seat part frame adjacent to the opposite harder side. A storage hoop is provided with hoop ends, respectively connected to the respective pivotable hoop connections. The storage hoop is received in the recess to extend along the recess contour in a stowed position. In the stowed position a periphery of the storage hoop is just inward of the plane of the planar surface, or has a portion that is in the plane of the planar surface. With this configuration, the planar surface, with the storage hoop received in the recess in the stowed position, is essentially flat. With the storage hoop stowed in the recess, the planar surface does not interfere with adjacent items and can be deployed as a load floor. The storage hoop pivots between the stowed position, with the storage hoop extending along and within the recess, to a hoop deployed position, with the hoop extending outwardly from the opposite harder side.

The fittings that define the seat base to backrest pivot connection may be configured for pivoting the seat base relative to the backrest between a seating position and a stadium flipped up position. The hoop is deployed by pivoting the hoop down to a horizontal position such that the hoop extends outwardly from the opposite harder side defining the surface with the recess.

The fittings that define the seat base to backrest pivot connection may be configured for pivoting the backrest from a use position (a design position with the backrest slightly at an angle to vertical to support an occupant for travel) to a folded down position with the backrest horizontally disposed or at an angle to horizontal. The folded down position advantageously facilitates use of the opposite harder side, with a planar surface, as a load floor. The hoop is deployed from the use position of the seat by pivoting the hoop down to a horizontal position such that the hoop extends outwardly from the opposite harder side defining the surface with the recess.

With each of the fitting configurations, the storage hoop may also be deployed in a vehicle seat use position and/or in the vehicle seat pivoted position. For example with the fitting configured to move the seat base to the stadium flipped up position, the storage hoop may be deployed to extend horizontally with the seat base in the stadium flipped up position. In the use position the seat base is down and extends essentially horizontally. The hoop may be configured to be pivoted down so as to extend vertically down from the seat base. In such a deployed position, the distal edge of the hoop may run horizontally and parallel to a vehicle floor, and spaced from the vehicle floor to support items on the vehicle floor. Similarly, with the fitting configured to pivot the backrest forward to provide the backpanel as a load floor, the storage hoop may be deployed to extend horizontally with the backrest in the use (design) position. In the pivoted forward, load floor, position the backrest is pivoted down and extends essentially horizontally. The hoop may be configured to be pivoted up so as to extend vertically up from the backpanel of the backrest. In such a deployed position, the distal edge of the hoop may run horizontally and parallel to the load floor (backpanel surface), and spaced from the load floor to support items on the load floor. Further, any of the seat parts may have more than one storage hoop. For example nested storage hoops of different sizes may be provided.

According to an aspect of the invention, a vehicle rear seat is provided with a backrest and with a seat base, that is connected to the backrest such that the seat base can pivot up to a stadium flipped up position. The harder side with the planar surface comprises an underside of the seat base with a storage hoop pivotably connected to the seat base at hoop pivot connections. The hoop pivot connections have pivot locations that are toward or near to the seat base pivot of the seat base. With the seat base in a stadium flipped up position and with the hoop in a pivoted out state, the hoop extends outwardly and substantially horizontally from the seat base.

Any seat part that has an exposed lower side, namely a seat base with space below the seat base or has space behind a rear backrest can utilize this feature. The hoop may advantageously have attachment features for adhering straps, bungees, rope, etc.. to secure items inside and outside of the hoop. The straps will provide storage in the vertical as well as horizontal position of the backrest assembly. The hoop may have additional hoop loops or hooks.

The hoop may be pivotably connected to the seat base, at the hoop pivot connections, so as to enable a locking cam feature of the seat base when the seat is in the stadium flipped up position and the hoop is in a pivoted out state (hoop deployed position). This locking feature may prevent the seat base (seat cushion) from pivoting down when the load is applied to the pivot through the hoop pivot. Advantageously the hoop pivot pulls a cable that rotates a cam to a position to lock with (engage) a detented region on the seat base pivot (cushion pivot).

The seat in the up position may have a structural frame, such as a secondary frame or accessory frame, pivot down to provide a storage hoop. This hoop may be moveable to extend forward to provide more space within the hoop. The hoop may include features such that when the hoop is pivoted down, it may extend outwardly away from the seat part. This may be provided based on telescopic arms of the storage hoop, that moves the distal edge of the hoop relative to the hoop pivots.

The hoop may act as a shelf for extra storage space, forming a support for a shelf surface for an extra level of storage. This may be a ridged covering which is directly supported by the hoop or supported by a frame on the b-side of the seat base (underside of the cushion) or rear backrest. Such a support frame allows movement of the rigid covering to change the position of the surface of the rigid covering. The covering may also be flexible and may be, for example, supported by the hoop and extend between edges of the hoop.

The harder side with the planar surface is a b-surface of the seat base (underside of the cushion) or rear backrest, which advantageously may have straps acting as or forming modular lightweight load-carrying equipment (M.O.L.L.E). This may advantageously cooperate with a hard panel surface forming the harder side. For example, the harder side may have grooves and ridges or recesses relative to the common plane (planar surface) cooperating with the straps for further storage possibilities.

Any seat that has a configurable seat base (cushion) or backrest (seatback) can utilize the features according to the invention. Additionally, a seat that fully pivots backwards can also utilize such a pivoting storage hoop. In the embodiments, the hoop acts as a structural support, pivot to extend out, and may have attachment points for straps, nets, bags, pockets etc.

The invention provides a seating system and a vehicle seating arrangement and vehicle seats that maximize the utilization of storage space. The invention provides a storage system that secures and protects items, including potentially both short and long term storage items. The invention provides good accessibility to stored items as well as ease of reconfiguring, intuitive use and user mode adaptability.

A vehicle seat backrest assembly may be provided comprising a backrest frame, tube bracket supports fixed to the backrest frame, and a backrest storage hoop tube assembly. The backrest frame supports foam and trim applied to one side and has an opposites harder side defining a planar surface and a recess with a recess contour. The hoop tube assembly ,may comprise pivotable hoop connections pivotably connected to the tube bracket supports, and a storage hoop with hoop ends respectively connected to the respective pivotable hoop connections. The storage hoop pivots between a stowed position with the storage hoop extending along the backrest frame to a hoop deployed position with the hoop extending rearwardly of the backpanel. In the stowed position, the hoop is within the recess, so as to essentially be on a backrest frame side of a common plane of the planar surface or with a portion of the storage hoop just slightly in the common plane. In this way, the planar surface with the storage hoop stored in the recess, provides an essentially flat surface for the opposite harder side. With the configuration the opposite harder side functions as a load floor, with the hoop within the recess in the stowed position.

The tube bracket supports may comprise bracket pivots and a radially outward support locking abutment. The pivotable hoop connections may comprise tube bracket bushings, each of the bracket bushings receiving one of the bracket pivots. At least one of the pivotable hoop connections may further comprise a bracket abutment for engaging the support locking abutment in the deployed position and to limit a range of pivoting movement of the storage hoop relative to the backrest, whereby the tube bracket supports pivot about the bracket pivots between the stowed position and the deployed position defined by the bracket abutment engaging the support locking abutment. The backrest may comprise a backrest pivot and/or a backrest pivot fitting support. The tube bracket supports may be spaced from the backrest pivot and/or a backrest pivot fitting support.

A backpanel for the backrest frame may comprises a backrest support tube, wherein the backpanel is supported by the support tube. The backpanel comprises a backpanel rear surface with a hoop tube recess receiving the storage hoop in the stowed position. The storage hoop may comprise an outer U-shaped hoop part with first and second U-shaped hoop ends respectively connected to the pivotable hoop connections. The backpanel may advantageously comprise a hard panel surface.

A vehicle seat arrangement may be provided comprising front seats; and at least one rearward seat, disposed rearwardly of the front seats. The rearward seat comprise a backrest comprising a backrest frame; tube bracket supports fixed to the backrest frame; and a backrest storage hoop tube assembly. The backrest assembly comprises a pivotable hoop connections pivotably connected to the tube bracket supports; and a storage hoop with hoop ends respectively connected to the respective pivotable hoop connections, whereby the storage hoop pivots between a stowed position with the storage hoop extending along the backrest frame to a hoop deployed position with the hoop extending rearwardly of the backpanel. The seat base has seat base fittings forming a part of pivot connections between the backrest and the seat base for pivoting the backrest forward relative to the seat base between a seating position and a forward load floor position.

Features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1A is a perspective schematic view showing a vehicle seat configuration with rear stadium flip up seats flipped up and with storage hoops in a stowed position;

FIG. 1B is a perspective schematic view showing the vehicle seat configuration of FIG. 1A with storage hoops in a deployed position;

FIG. 2 is a perspective view showing a vehicle seat according to the invention with stadium seating feature and with a storage hoop;

FIG. 3 is a perspective view showing the vehicle seat of FIG. 2 with the bottom seat flipped up and with the storage hoop in a stowed position;

FIG. 4 is a perspective view showing the vehicle seat of FIG. 2 with the seat base flipped up and with the storage hoop in a hoop deployed position;

FIG. 5A is a front perspective view of a 60/40 rearward vehicle seat arrangement of seat bases of vehicle seats with the stadium seating feature showing the seat base flipped up and with storage hoops in a stowed position;

FIG. 5B is a front perspective view of the seat bases of the vehicle seat arrangement of FIG. 5A with storage hoops in a deployed position;

FIG. 6 is a view showing steps in a process for manufacturing a seat assembly with a seat base;

FIG. 7 is a perspective view showing a base frame structure with added pivot brackets;

FIG. 8 is a perspective view showing the base frame structure with hoop pivot structure;

FIG. 9 is a cutaway perspective view showing a cable assembly connected to the hoop pivot structure;

FIG. 10 is a perspective view showing the base structure with hoop pivot structure and cable assembly and with trim and foam shown in dashed line;

FIG. 11 is a perspective view showing the hard panel assembly with M.O.L.L.E.

attachments at a bottom side (planar surface) of the seat base structure of FIG. 10;

FIG. 12 is an exploded view of a hoop assembly;

FIG. 13 is a perspective view of an inertial lock of the seat base fitting (pivot structure) with added cable actuated latch;

FIG. 14 is a perspective view of the seat base structure of FIG. 11 with connected hoop assembly;

FIG. 15 is a perspective schematic view showing an alternative embodiment;

FIG. 16A is a rear side perspective view showing a vehicle seat backrest with an integrated rear storage hoop in a stowed position;

FIG. 16B is a rear side perspective view showing the vehicle seat with the integrated rear storage hoop in a deployed position;

FIG. 17 is a front perspective view showing a vehicle seat backrest frame, showing a backpanel, and showing the storage hoop in the deployed position;

FIG. 18 is a side view showing the vehicle seat backrest frame and backpanel of

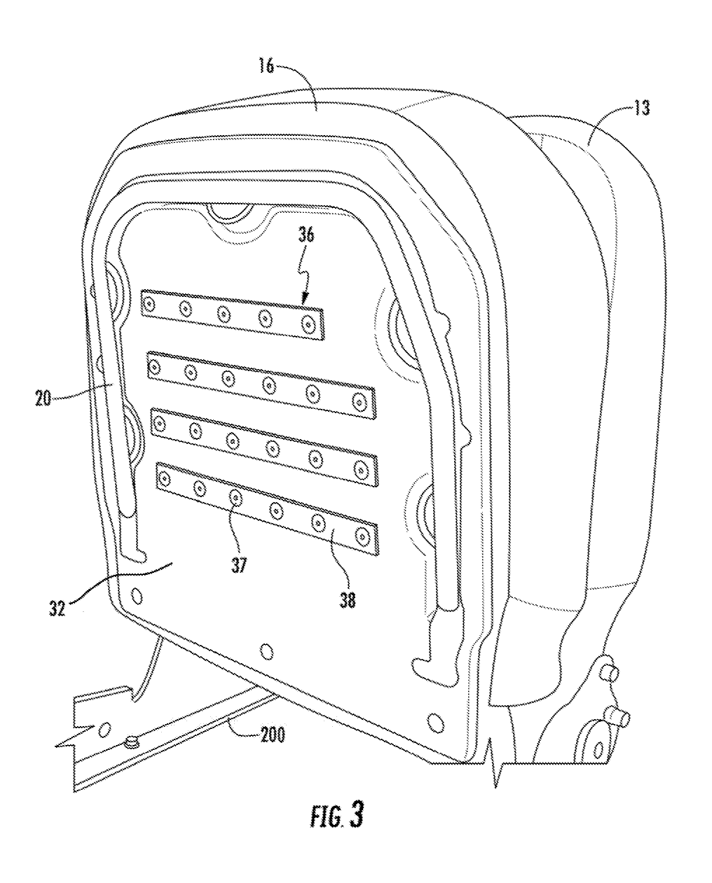

FIG. 2 with the storage hoop in the deployed position;

FIG. 19 is a top view of the vehicle seat backrest frame and backpanel of FIG. 2 with the storage hoop in the deployed position;

FIG. 20 is a cutaway side detail view showing a storage hoop bracket to pivot connection with deployed position locking feature;

FIG. 21 is a cutaway rear perspective detail view showing the storage hoop bracket to pivot connection;

FIG. 22 is a rear view of the vehicle seat backrest backpanel;

FIG. 23A is a schematic top view showing a vehicle seat arrangement with a rearmost seat adjacent to a rear storage area with an integrated rear storage hoop in a stowed position; and

FIG. 23B is a schematic top view showing a vehicle seat arrangement with the rearmost seat adjacent to the rear storage area with the integrated rear storage hoop in a deployed position.

### DESCRIPTION OF THE PREFERRED EMBODIMENTS

Referring to the drawings, Figures lA and 1B show several features of rear vehicle seats (rearward seats) according to the invention. A seat arrangement generally designated 10 includes two seats generally designated 12. The arrangement could have a single bench seat and advantageously includes two seats such as a 50/50 seat arrangement or a 40/60 arrangement of two seats 12. Each seat 12 includes a backrest (seatback) 13 and a seat base (cushion) 16. Each seat base 16 has an underside (b-side) 9 with a storage hoop 20.

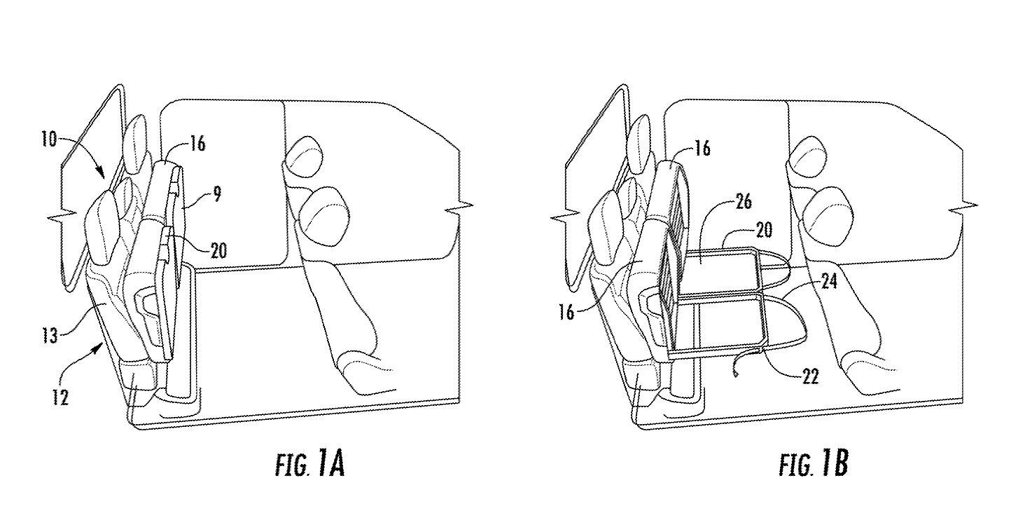

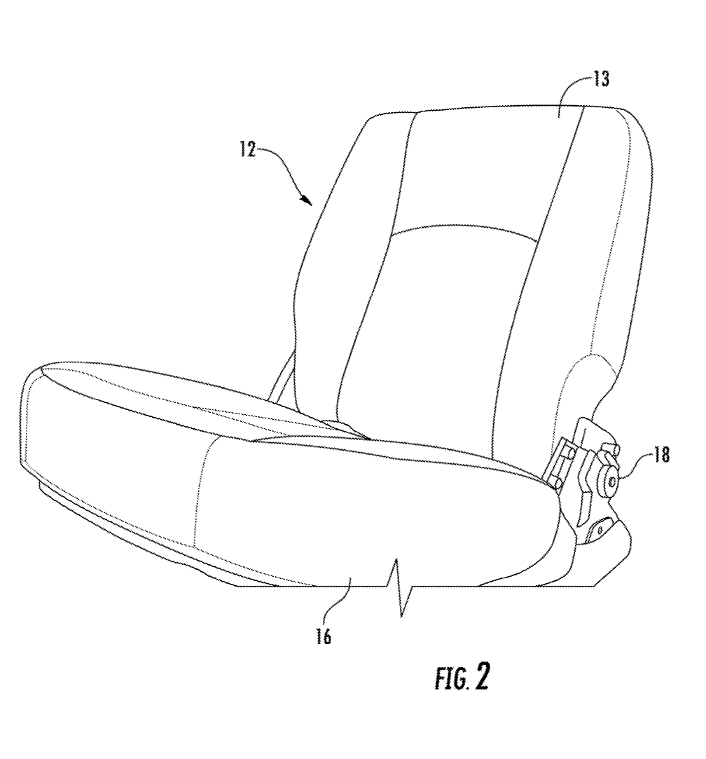

FIG. 1A shows the two seat bases 16 in a stadium flipped up position and with the storage hoops 20 in a stowed position. FIG. 1B shows the storage hoops 20 in a hoop deployed position, pivoted relative to the underside 9. The storage hoop 20 has attachment features such as additional loops or pass-through slots 22 that can receive one or more straps 24. In addition, a shelf surface 26, for an extra level of storage, is supported by the storage hoop 20. The shelf surface 26 may be flexible and attached to the storage hoop 20 at various points. The shelf surface 26 may be retractable and stored in a role. The shelf surface or tray 26 may also be rigid and be connected and disconnected as necessary.

FIG. 2 shows one of the seats 12 with stadium seating feature. The seat base 16 is shown in a seated position. The seat base 16 is connected to supporting structure and to the backrest 13 by a pivot structure (fitting part) generally designated 18, with an inertial latch. The adjacent seat 12, whether it is a 50%, 40% or 60% sized seat, will have similar features. The features of the two seats are essentially mirrored with the pivot structures (fitting) 18, 18′ on opposite sides. The seat base 16 has the upper trim side, with trim and foam (upper, with the seat base in the use/design position). The seat base 16 has an opposite harder side 32 with a planar surface 9 at an underside of the seat base 16. The seat base 16 is biased into a flipped position by a spring associated with the pivot structure 18. The seats can normally be pivoted down (against the spring bias). The inertial latch associated with the pivot structure 18 holds the position of the seat base 16 in the case of an inertial load (a crash situation).

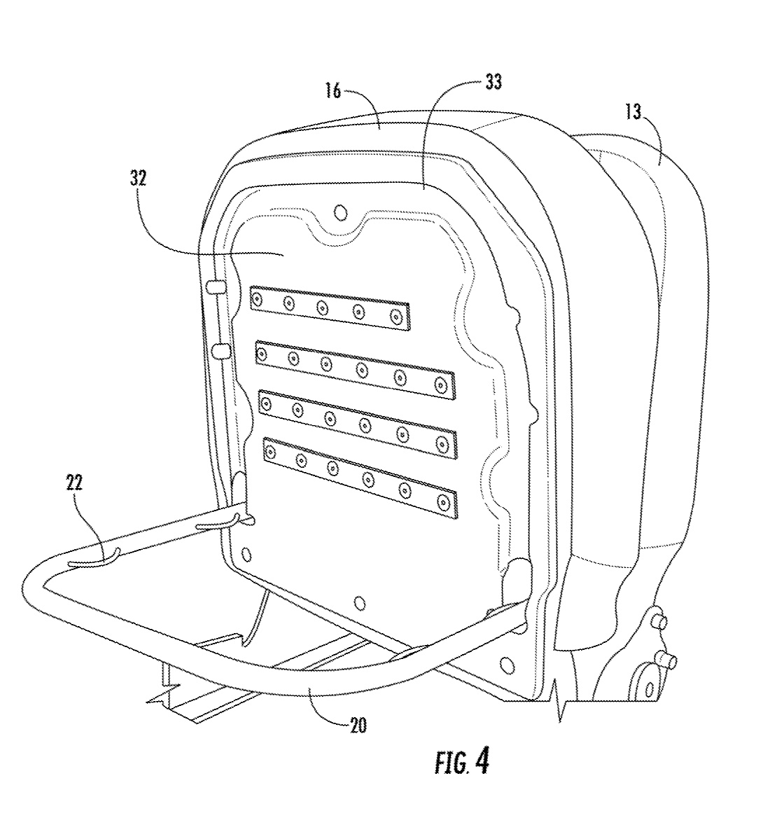

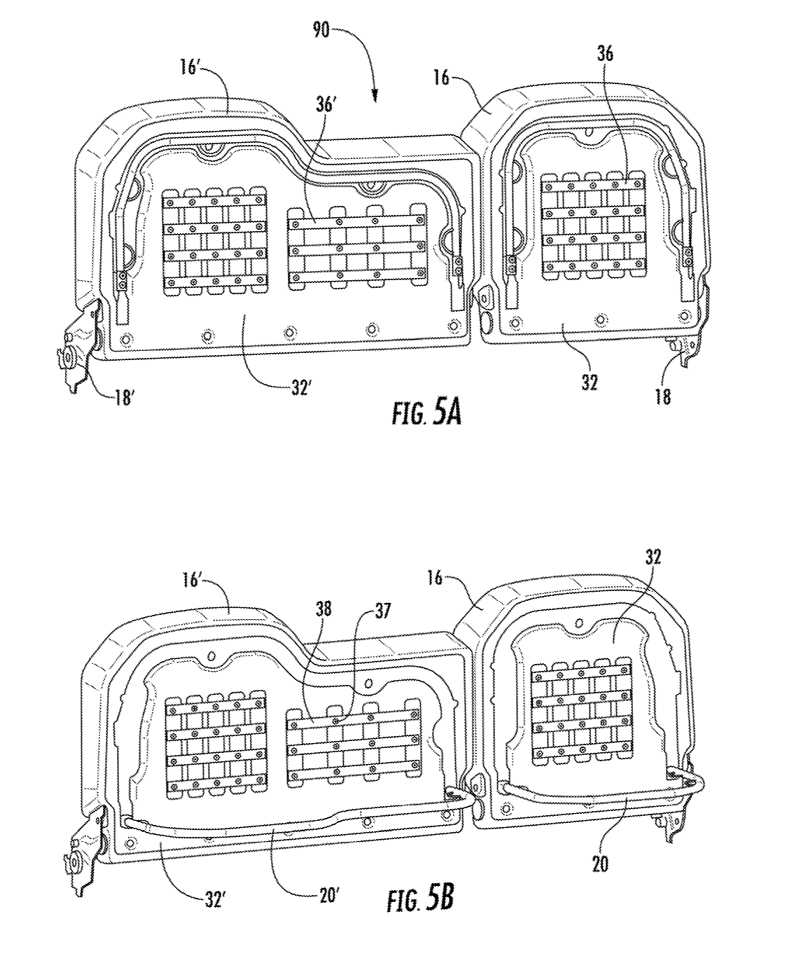

FIGS. 3 and 4 show the seat 12 in a flipped up position. The planar surface 9, at the underside, is provided by a hardshell (plastic, metal, textile) 32. The seat with the connected hardshell 32 supports a storage hoop 20. The hardshell 32 with the essentially planar surface 9 (at least in portions thereof) supports storage features, particularly in the form of a plurality of support points 37 with nylon bands 38 for supporting various items. This may be in the form of a modular lightweight load-carrying equipment (M.O.L.L.E) and is referenced hereinafter as M.O.L.L.E 36. Other pockets and support structures may also be provided attached to the hardshell 32. In FIG. 4 the storage hoop 20 is in a hoop deployed position. From this view it can also be seen that the hardshell 32 includes a receiving groove 33 to accommodate the storage hoop 20. This positions the storage hoop 20 inward, relative to the common plane of the planar surface of the rear surface of the hardshell 32, or just slightly in the common plane. In FIG. 4 it can also be seen that the storage hoop 20 includes loop structures 22 for attaching items or attaching items via bungee cords or straps or the like. The receiving groove 33 is shaped to accommodate the loop structures 22.

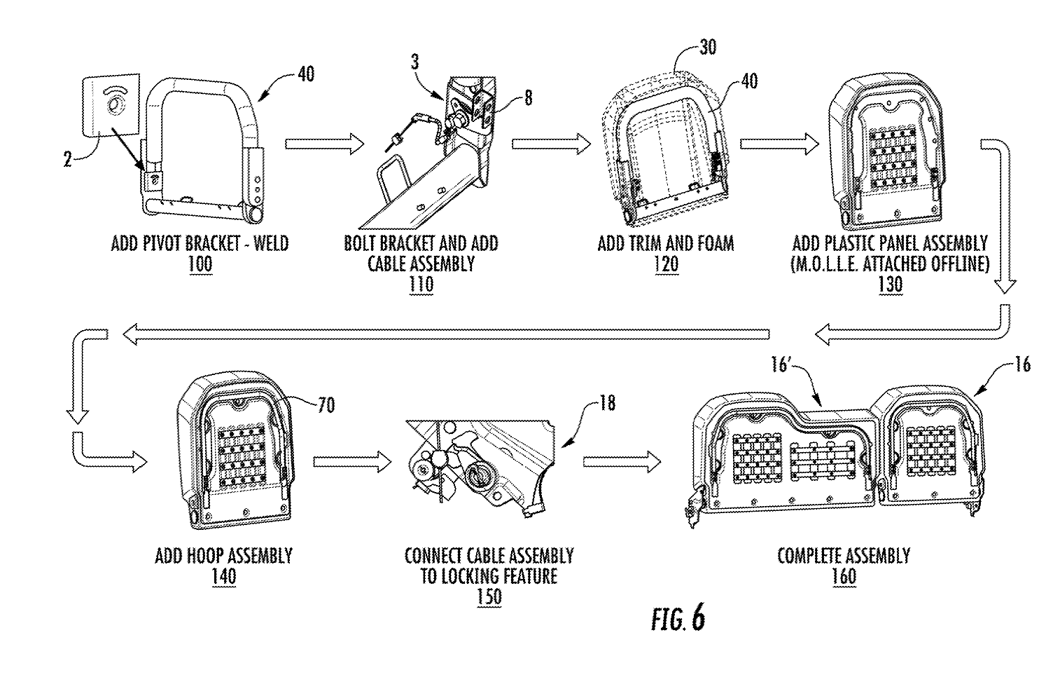

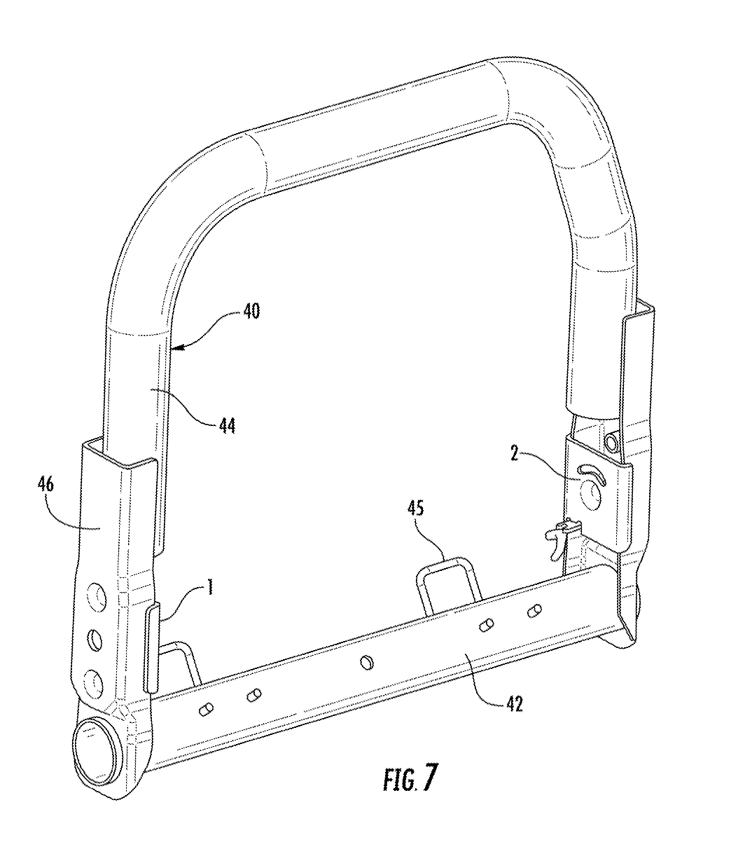

FIG. 5A shows a seat arrangement 90 with a seat base 16′ and an adjacent seat base 16, providing a 60/40 arrangement. FIG. 5A shows the opposite pivot structures (fitting part) 18 and 18′ as well as the hardshell 32 and 32′ and M.O.L.L.E 36 and 36′. In FIG. 5B the two storage hoops 20 and 20′ are shown in the hoop deployed position. Although the dimensions and shapes of the two seat bases 16 and 16′ are different, the construction is essentially the same. Accordingly in the following the construction of one of the seats is described with it being appreciated that other seat parts of other relative dimensions can be provided in a similar manner.

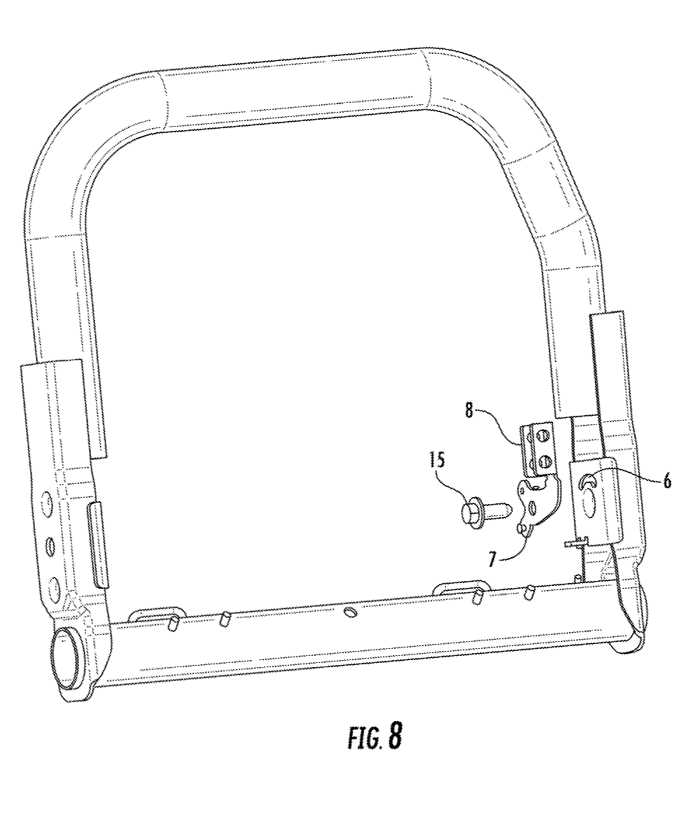

Particular steps for manufacturing a seat according to the invention are shown in FIG. 6. The process starts at 100 with a seat base frame structure 40. Hoop pivot brackets 2 are added, such as by welding. As shown at step 110 a cable assembly 3 and bolt bracket 8 are attached. Trim and foam 30 are added to the seat base frame structure 40 as shown at step 120. The hardshell (plastic panel assembly) 32 is added, including M.O.L.L.E 36. The hoop tube assembly 70 is connected as shown at step 140. The cable 56 of the cable assembly 3 is connected to the latch cam locking feature at the pivot arrangement 18 as shown in step 150. The full assembly with seat base 16′ and seat base 16 is provided as shown at step 160.

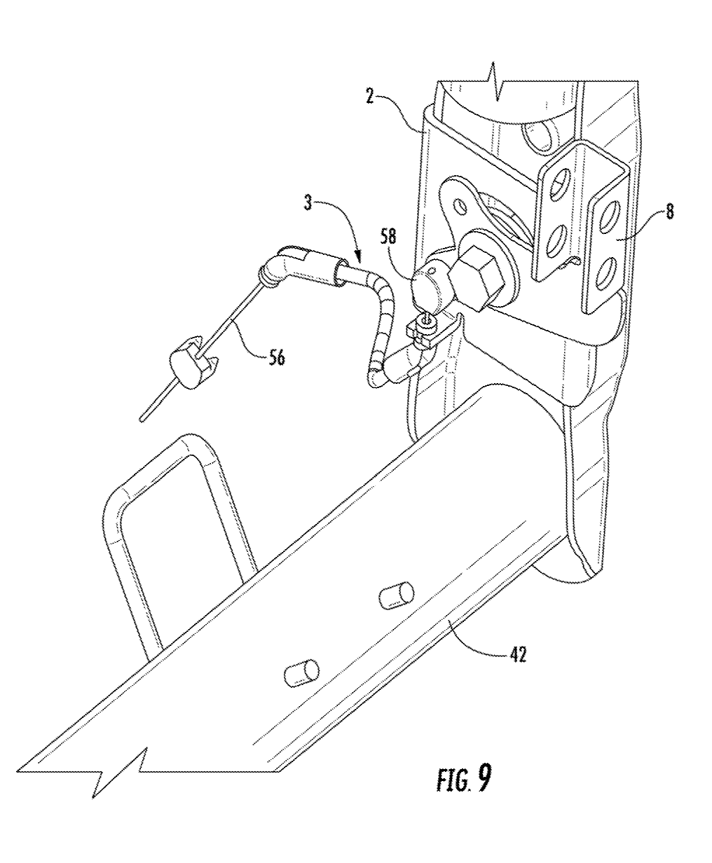

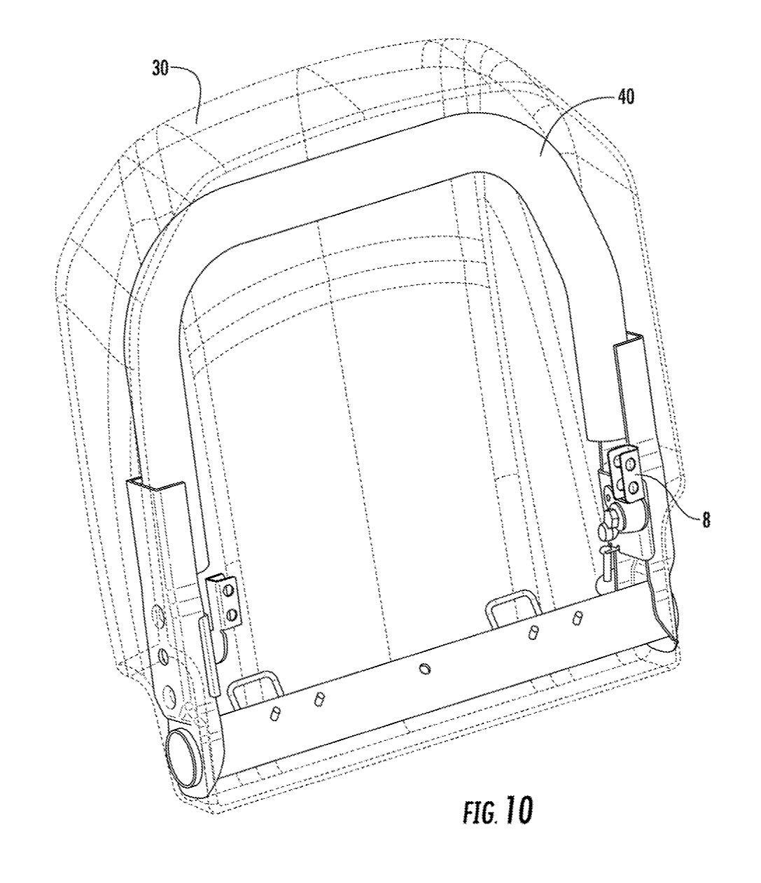

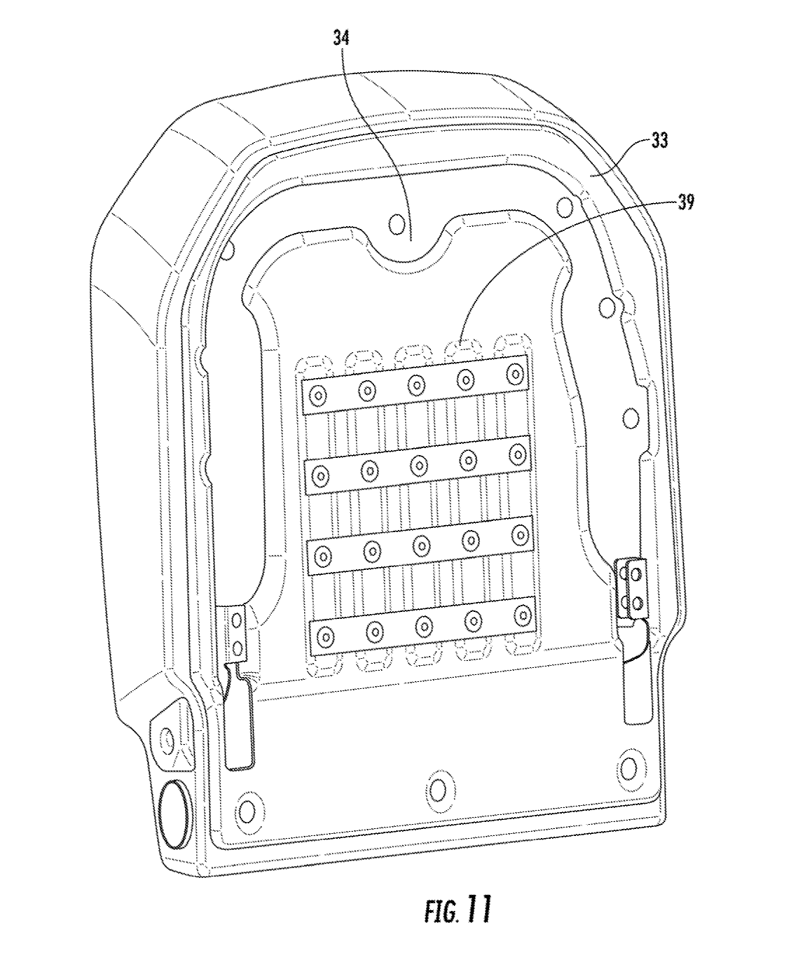

As shown in FIG. 7, the seat base frame structure 40 includes two hoop pivot plates 1 and 2 as well as the cross tube 42 with feature 45. The cross tube 42 is connected by brackets 46 to the base support tube 44. As shown in FIG. 8, the hoop bracket 8 is connected by a bolt 15 to the pivot plate 1, 2 to allow the hoop bracket 8 to pivot along guide 6. The hoop bracket 8 has an end 7 for connection to the cable assembly 3. The cable assembly 3 is shown in FIG. 9 with a connection end 58 of the cable 56 connected to the end 7 of the hoop bracket 8. After these features are connected, the foam and trim 30 are connected to the seat base frame structure 40 as shown in FIG. 10.

After the foam and trim 30 have been connected, the hard panel 32 is fixed to the foam 30 and the seat base frame structure 40. The bracket 8 passes through the hard panel assembly 32. The hard panel assembly 32 includes recessed portions 33 and 34 that accommodate features of the storage hoop 20. The hard panel assembly 32 may also include grooves or channels or are protruding parts 39 that cooperate with the features of the M.O.L.L.E 36.

FIG. 12 shows the hoop tube assembly 70 in an exploded form. The hoop tube 11 is connected to brackets 5 and 8 via opening passages in the tube 11 and nut and bolts sets 14. Bolt sets 14 pass through respective opening passages in the tube 11 to fix the tube 11 to the respective brackets 5 and 8. The hoop tube 11 may be a multi part construction with two side arms 11a and 11b respectively extending from brackets 5 and 8 to connection ends connecting with an outer U-shaped hoop part 11c. The outer U-shaped hoop part 11c is mounted in the respective connection ends of side arms 11a and 11b to slide outwardly relative to the two side arms 11a and 11b in a telescoping manner. The telescoping U-shaped hoop part 11c and side arms 11a and 11b allow the hoop 11 to extend further outwardly. FIG. 12 also shows the brackets 1 and 2 as well as the cable assembly 3.

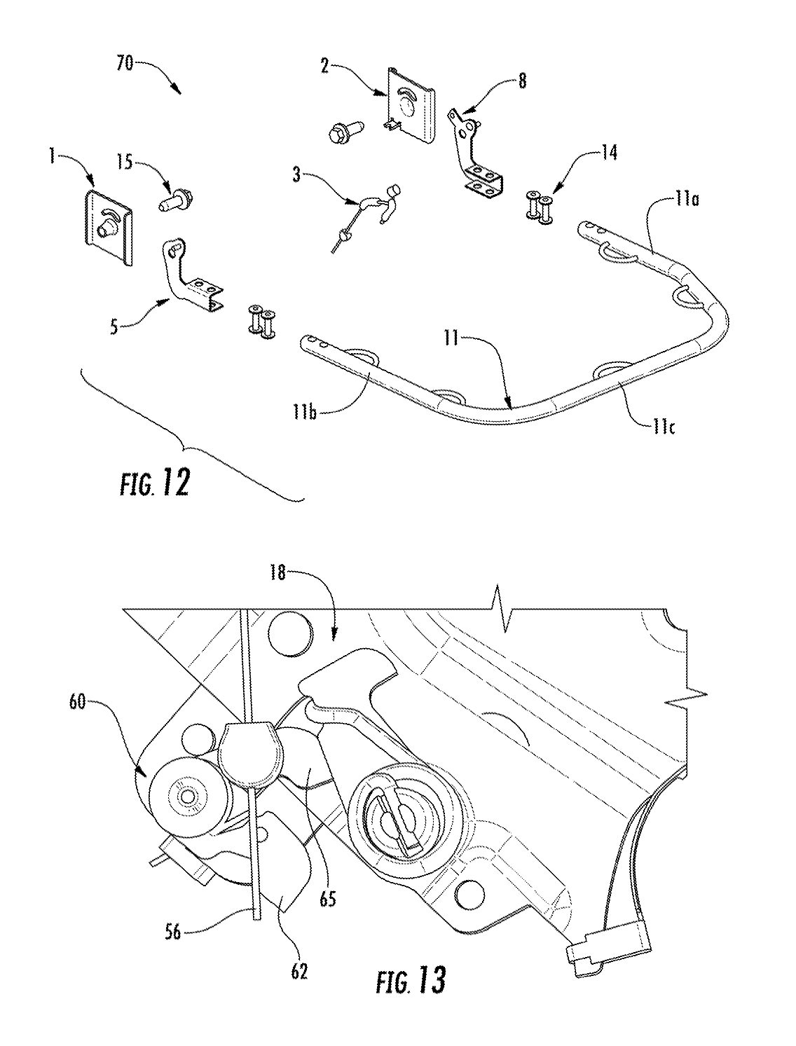

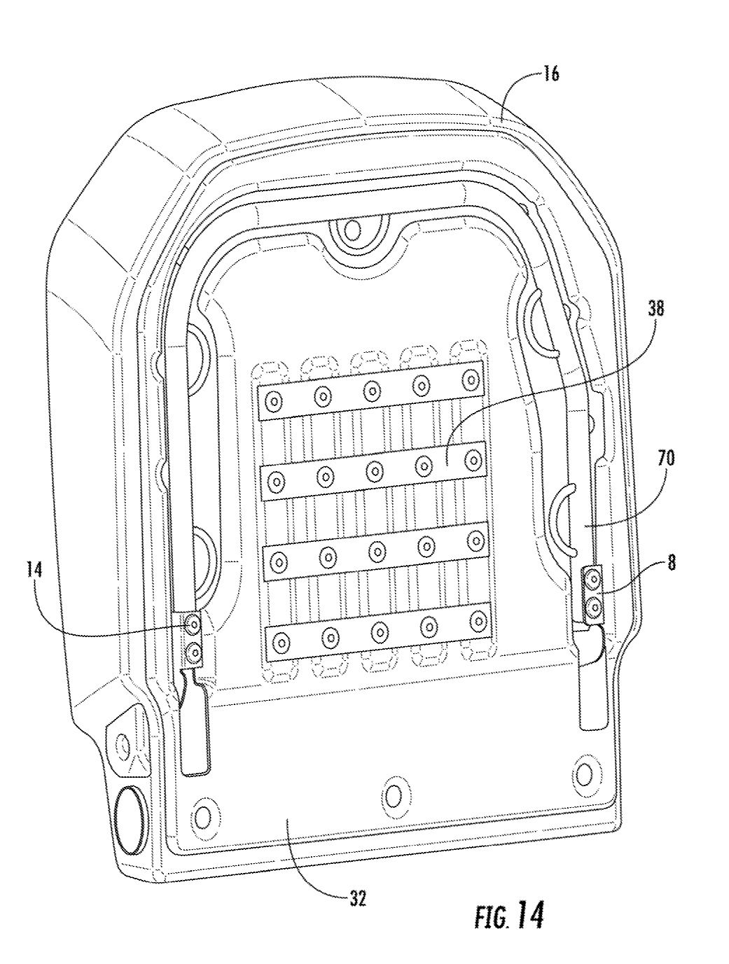

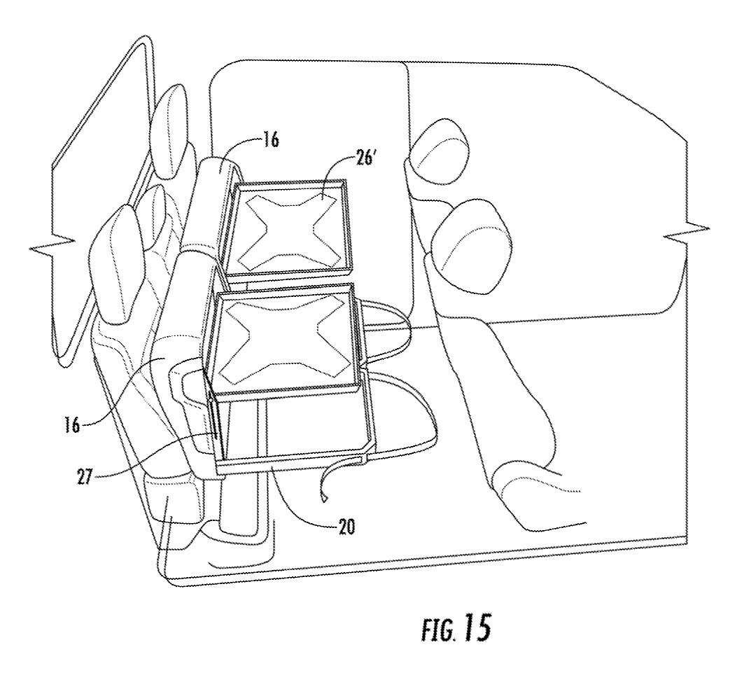

After the tube 11 is connected to the seat base frame structure 40 and hence to the remainder of the seat base 16, the cable 56 can be connected to a latch cam (cable actuated latch) 65 of the inertial lock 60 associated with the pivot arrangement 18. As is generally known, a latch lock such as latch lock 60 of the seat fitting 18 may include a locking cam 62 that moves into a locked state when the seat base is subjected to an inertial load that exceeds a crash threshold. The invention may provide a latch cam 65 that is moved into a locked state, as shown in FIG. 13, when the storage hoop 20 is moved from the stowed position to the deployed position. This occurs as the hoop bracket 8 pivots with the tube 11 and pulls cable 56. As shown in FIG. 13, cable 56 is connected to the latch cam 65, which then rotates into the locked position. With the latch cam 65 in a locked position the seat base 16 is prevented from pivoting down when a load is applied to the pivot bracket 8 via the storage hoop 20.

FIG. 14 shows the seat base structure connected with the hoop tube assembly 70. The hoop tube assembly 70 is connected via cap nuts 14 to the bracket 8. The pivoting motion of the storage hoop 20 brings about the locking of the seat base 16, as noted above. During the pivoting motion, features stored with the M.O.L.L.E 36 are not interfered with.

FIG. 15 schematically shows an alternative seat arrangement and seat embodiment in which the seat base 16 is constructed essentially in the same way as discussed above. However, the hard panel assembly 32 includes a guide frame structure 27 defining a support guideway for holding a tray or shelf surface 26′. In this embodiment, the shelf surface 26′ is rigid or is fabric or a net and which may be supported in a stretched taught state.

Preferably, the attachment to the guide frame 27 allows the tray to be raised and lowered and set, such as by pins or posts cooperating with a set of setting detents, in position in any location along the guide frame 27. The attachment to the guide frame 27 may be a detachable connection. The tray/shelf surface 26′ may also be fixed to move along the guide frame 27 and to be positionable flush with the storage hoop 20 for pivoting up with the storage hoop 20, from a deployed position to a stowed position.

Although the examples shown in FIGS. 1A, 1B and 15 relate to a pickup truck type cab, particularly with a rear seat that is adjacent to a rear wall of the pickup truck cab, the invention may be used for other arrangements, including middle seats and rear most seats which are not at a cab rear wall. Further, where there is space behind the seat, the backrest may have a storage hoop, which is deployed rearward. Further, the seat base may have a storage hoop and be rotated over backwards, such that the planar surface acts as a load floor with the hoop attached to the seat base extending rearwards.

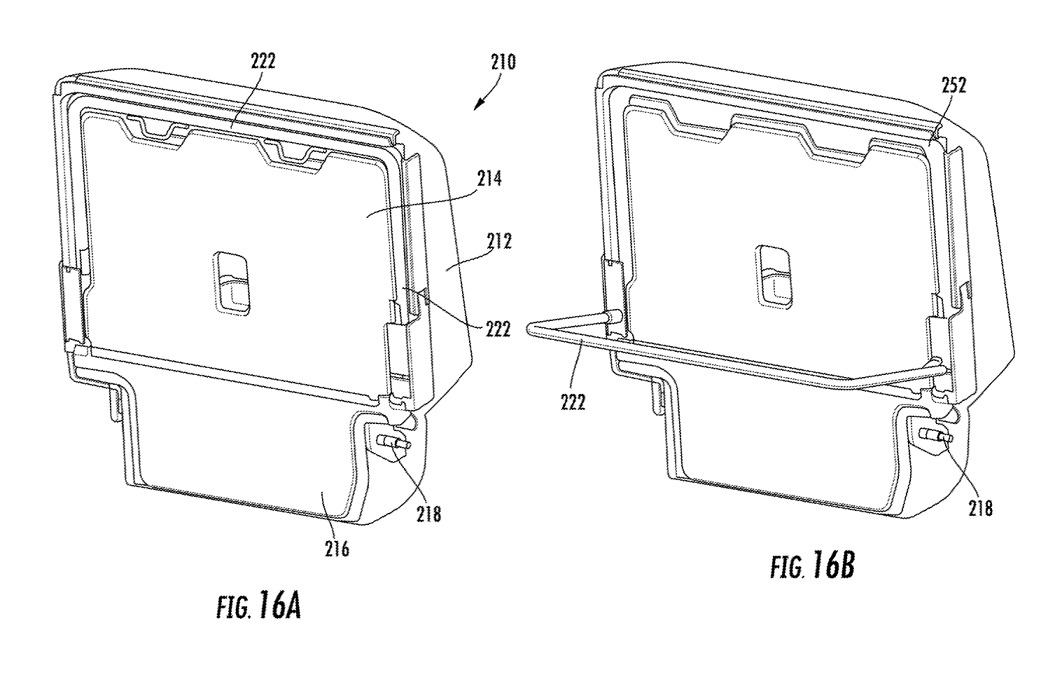

FIG. 16A shows a backrest (seatback) assembly generally designated 210 that is a part of a rear vehicle seat 202. The backrest assembly 210 comprises a hoop assembly generally designated 220 with a hoop tube 222. The backrest assembly 210 comprises a backrest comprised of a backrest frame 240 with a backrest frame tube 242 (FIG. 17). The hoop assembly 220 comprises the hoop 222 and tube brackets 224 and 234. The hoop tube 222 has tube interface ends 235 that are connected respectively to the brackets 224 and 234. The hoop assembly 220 is connected to the backrest frame 240 and can pivot between a stowed position (FIG. 16A, 23A) and a deployed position (FIG. 16B, 23B). The backrest assembly 210 is a part of the rear vehicle seat 202 that is adjacent to a rear storage space 206. An essentially identical rear vehicle seat 202 is positioned at the other side. The seats may be left and right hand versions, with the pivot fixture 218 (for locking a position and releasing a position to pivot the backrest forward) at an outboard side and a passive pivot at the inboard side of each seat 202. The rearmost vehicle seats 202 are shown as 50/50 seats (each occupying about half of the vehicle interior lateral space) but may advantageously be provided as 60/40 seats (one seat occupying about 60% of the interior lateral space and the other occupying about 40% of the interior lateral space). The rear vehicle seats 202 are parts of a vehicle seat arrangement 207 that also comprises the front seats 204 and the rear storage space 206 (FIGS. 23A and 23B). The vehicle seat arrangement 207 is provided in a vehicle 201, that may be for example an SUV, a station wagon, a van/minivan, a hatchback, a sedan or other vehicle that includes such a rear storage space 6.

The backrest assembly 210 further includes a backrest trim/foam side or front (occupant engaging) side and an opposite rear, harder side with a planar surface comprised of a backrest back panel 214 with a toe kick/back panel base 216. The backrest assembly 210 can pivot forward such that the back panel 214 becomes a load floor of a rear storage space 206. With an SUV or the like the storage space 206 is expanded with the rear seats folded (pivoted) down. Particularly with the backrest assembly 210 in the seating position (as shown in FIGS. 16A, 16B, 23A and 23B) the hoop assembly 220 can be pivoted out to extend into the rear storage area 206 of the vehicle 201 (FIG. 23B). With this configuration, the hoop assembly 220 provides support in the rear storage area 206 for items stored in the rear storage area 206.

The backrest panel 214 is connected to the backrest frame tube 242 by support connections including a support flange 241. The front side of the backrest assembly 210 comprises backrest trim 212 that is supported by foam and the backrest frame 240, including the tube 242. The backrest assembly 210 further includes a pivot fixture support bracket 244 that is connected to the backrest frame tube 242 and to the back panel 214. The backrest frame tube 42 includes headrest support mount 246. At an opposite side of the backrest assembly 210, a backrest pivot support bracket 250 forms a support for a backrest pivot 218. The backrest pivot 218 as well as a pivot fixture connected to the pivot fixture support bracket 244 provide a pivoting connection for pivoting the backrest assembly 210 relative to a seat cushion (seat base) 208 of a vehicle seat generally designated 202. The backrest pivot 218 is mounted in a receiving bushing of the vehicle 201 and/or the seat cushion 208. The pivot fixture connects to pivot fixture interface 248 and blocks (locks) the backrest assembly 210 in position and releases the backrest assembly 210 to allow the backrest assembly 210 to pivot forward to expand the rear storage space 206, with one or both of the rear seats 202 folded (pivoted) down.

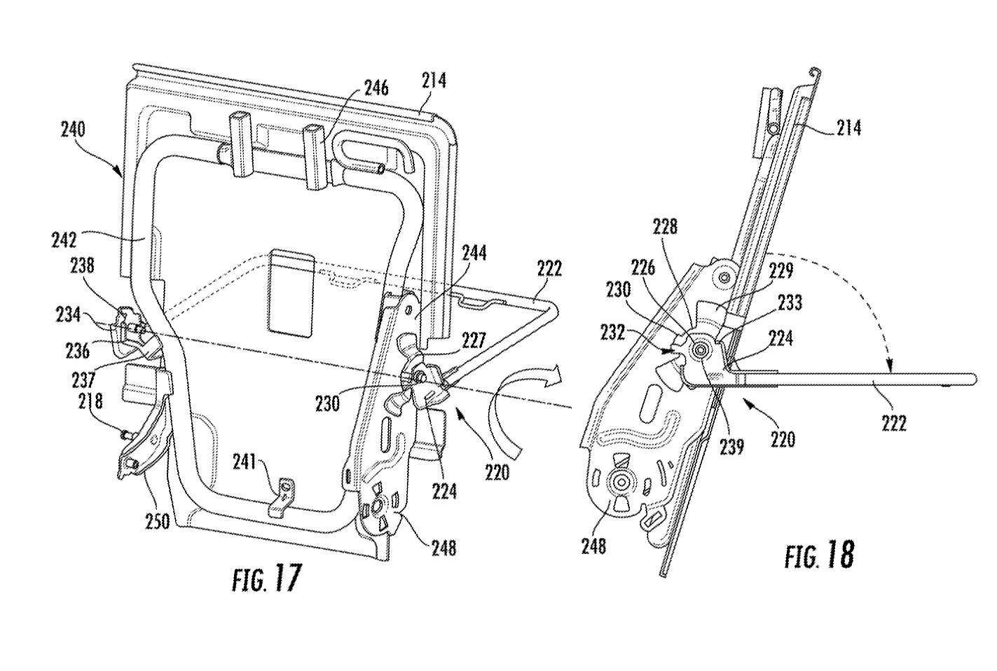

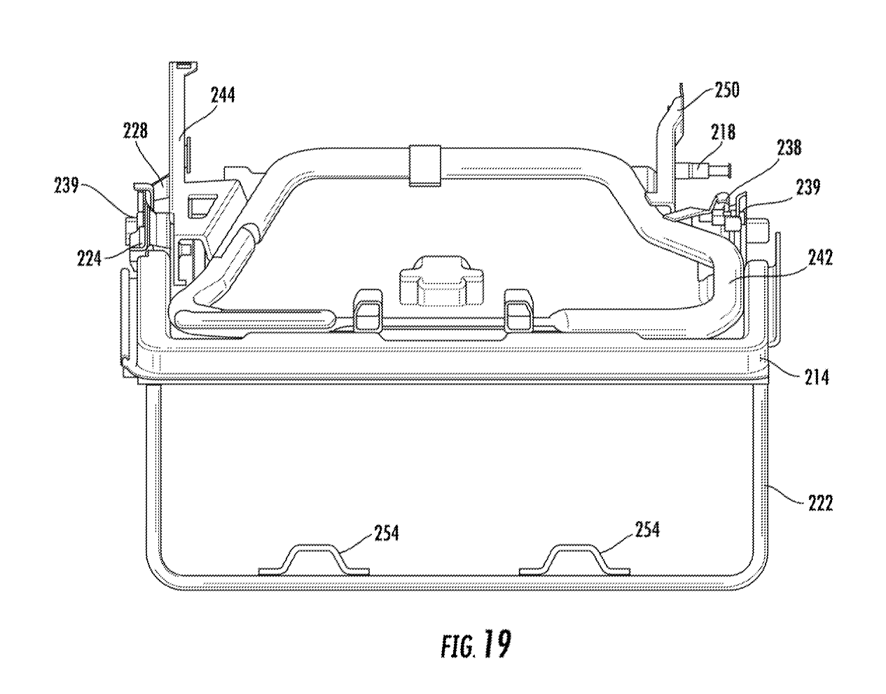

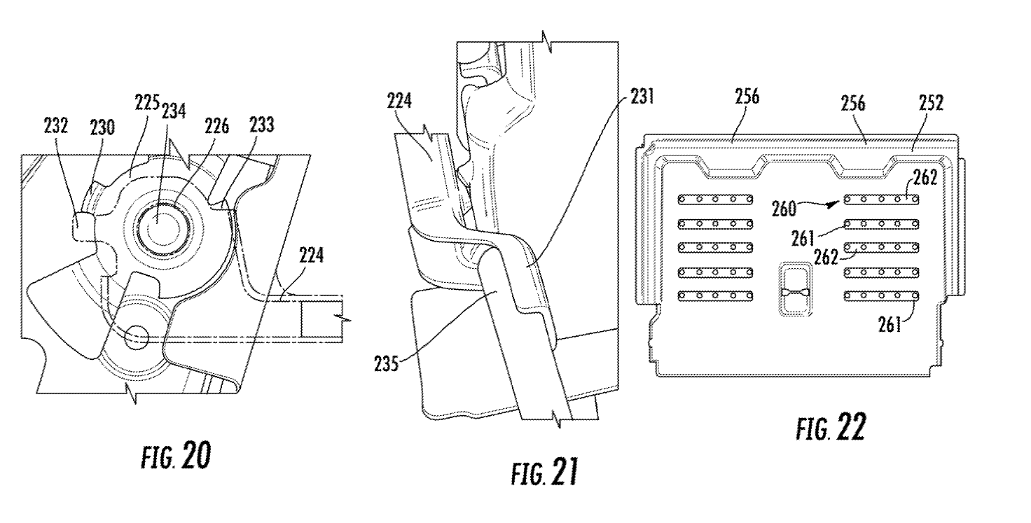

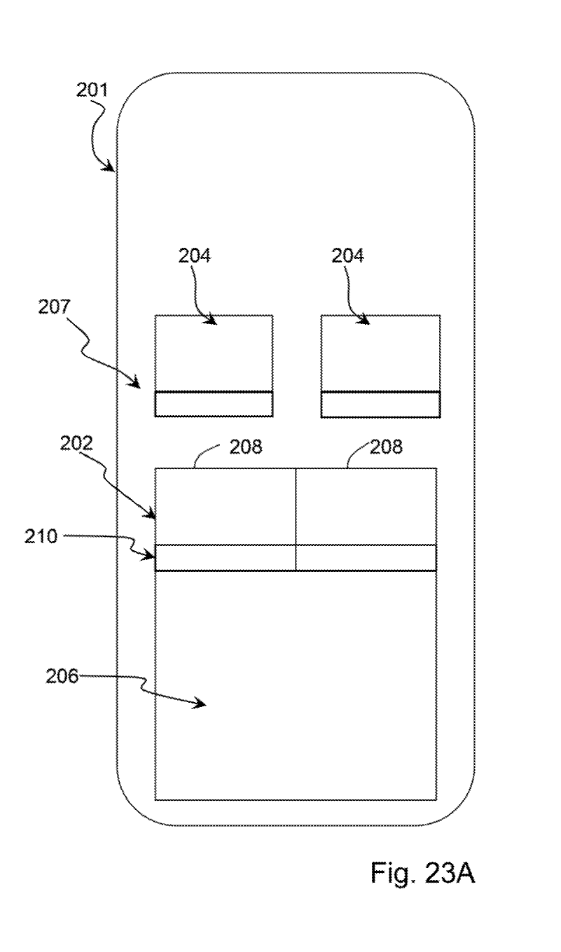

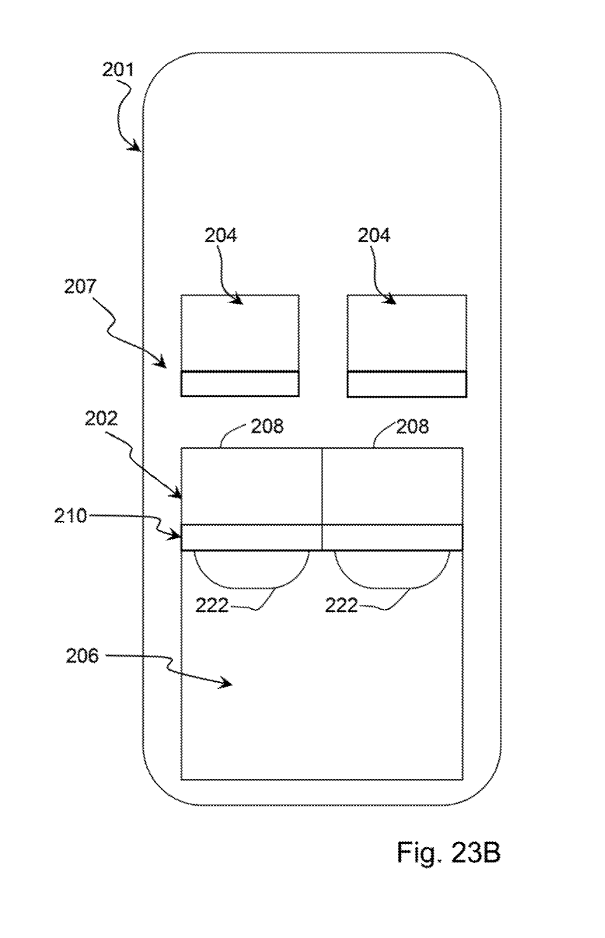

At the rear side, or harder side of the backpanel 214 with planar surface of the backrest assembly 210, the hoop tube assembly 220 is provided. The backrest storage hoop tube assembly 220 comprises pivotable hoop connections (brackets) 224, and 234. The hoop tube 222 has tube interface ends 235 which are respectively connected to the tube bracket pivots 224 and 234. The tube bracket supports 228 and 238 are fixed to the backrest frame 240. The tube bracket pivot 224 at one side and the tube bracket pivot 234 at the other side form the hoop pivot connections to mount the hoop tube assembly 220 to the backrest assembly 210 so that the hoop tube assembly 220 can pivot. The tube bracket 224 and 234 each include a tube bracket bushing 226 which respectively receive a pivot axle 239 (FIG. 18). The tube bracket pivots 224 and 234 are pivotably mounted at pivot supports 228 and 238, whereby the storage hoop 222 pivots between a stowed position with the storage hoop 222 extending along the backrest frame to a hoop deployed position with the hoop 222 extending rearwardly of the back panel 214 and into the rear storage space 206.

The pivot support 228 includes flange feet 229, leg parts 227 and a raised pivot support portion 225. The pivot support 228 is at a side of the backrest assembly 210 with the pivot fixture support bracket 244. The flange feet 229 are each fixed to the pivot fixture support bracket 244. The leg parts 227 of the bracket pivot support 228 extend laterally from the support flanges 29 to provide spacing between a pivot support portion 225 (FIG. 20) and the pivot fixture support bracket 244. The pivot support portion 225 supports the pivot axle 239. At the opposite side the pivot support 238 includes support interface flanges 237 and a pivot support portion 236. The pivot support 238 is connected directly to the frame tube 242 to support the pivot axle 239 for the other bracket pivot 234. The pivot support 238 is connected to the frame tube 242 via the pivot support interface flanges 237. The pivot support flange or two flanges 237 are fixed to the frame tube 242 and support the pivot support portion 236 outwardly of the backrest frame tube 242. The pivot support portion 236 forms the other tube bracket bushing 226. Each of the pivot axles 239 is received in a respective bracket bushing 226. This provides a pivot support for the hoop tube assembly 220.

The tube bracket support 228 includes a support locking abutment 230 which extends radially outwardly from the pivot support portion 225. The support locking abutment 230 forms a stop to limit the pivoting movement of the tube bracket 224 relative to the backrest frame 240, and to thereby limit the movement of the hoop 222. The tube bracket 224 includes a bracket abutment 232 with a stop surface that engages the support locking abutment 230 with the hoop tube assembly 220 in a deployed position of the hoop tube assembly (FIGS. 16B, 18 and 23B).

The storage hoop 222 comprises a single part outer U-shaped hoop part with first and second U-shaped hoop ends 235 respectively connected to the pivotable hoop connections 24 and 234. In the alternative, the storage hoop comprises a multi part construction comprising two side arms respectively extending from the pivotable hoop connections 224, 234 to telescopic connection ends that receive an outer U-shaped hoop part with first and second U-shaped hoop ends respectively connected to the connection ends of the two side arms. With this alternate configuration the outer U-shaped hoop part is mounted in the respective connection ends of side arms to telescopingly slide outwardly relative to the two side arms. This allows an adjustment of a size of a region encompassed by the storage hoop 222. Particulars of the telescopic U-shaped hoop part are described above with reference to FIG. 12.

The hoop tube 222 advantageously includes brackets 254 as attachment features. The brackets 254 cooperate with the storage hoop to form support loops which can be used in conjunction with straps or bungee cords or the like to fixed location of items relative to the hoop 222. The brackets 254 may include slots to receive belts or bungees. Further, the brackets 254 in combination with the hoop tube 222 forms a support to receive a shelf element and to form a shelf, with the hoop tube 222 and the deployed position. The position of the pivot axle 239 relative to the floor of the storage area 206 is selected such that the hoop tube 222, in the deployed position is about parallel to and spaced upwardly from the floor of the storage area 206. This spacing may also be selected so as to provide sufficient storage space above the shelf element as well as below the shelf element. Further, the pivot axle 239 may be supported so as to move upwardly and downwardly relative to the backrest frame and to be set and fixed in position along the backrest frame 240 so as to selectively position the pivot axle 239 and to adjust a height of the hoop part 222, in the deployed position, relative to the floor of the storage space 206. Further, an additional shelf with a guide frame structure to adjust a height position may be provided as described with reference to FIG. 1B. The shelf part comprises a shelf surface supported by the hoop part 222, the shelf surface being one of rigid and flexible and is advantageously provided as described above.

The back panel 214 is advantageously rigid, providing a ridged outer periphery as a hardside 214 of the backrest assembly 10. This hard side of the back panel 214 contributes structurally to the overall backrest frame 240. The outer periphery of the rigid back panel 214 has the planar surface (at least as a portion thereof) that provides the common plane and is particularly useful for forming a load floor with the backrest assembly pivoted forward to expand the rear storage space 206. The rigid back panel 214 advantageously has a back panel rear surface, the planar surface, with a hoop tube recess 252 receiving the storage hoop 222 in the stowed position (FIG. 16A). With the hoop tube 222 in the stowed position, the hoop tube 222 is inward of the common plane or just slightly in the common plane. The frame tube 242 can contribute structurally to the overall backrest frame 240. In particular, with the hoop tube 222 in the stored position within the hoop tube recess 52, the hoop tube 222 is inward of or just in the common plane of the outer periphery of the hardside 214. This is a position of the hoop tube 222 on a backrest frame side of the plane of the planar surface or just slightly in the plane of the planar surface. This allows the planar surface to function as a load floor.

With the storage hoop 222 in the hoop tube recess 252 a locking feature may be used to keep the hoop tube 222 in place within the recess 252. The locking feature may be straps with hook and loop (or hook and hook) fastener ends to maintain the hoop tube 222 in place within the recess 252. Other locking features may be used to maintain the hoop tube 222 in place within the recess 252. The shown embodiment includes resilient locking nubs 256. The resilient locking nubs 256 act with the hoop tube 222 with a snap action based on some resiliency of the locking nubs 222. The resilient locking nubs 256 are provided with the back panel 214 and extend from an edge of the hoop tube recess 252 toward the hoop tube recess 252. As the locking nubs 256 are resilient, the hoop tube 222 may be pressed passed the locking nubs 256 to seat the hoop tube 222 the hoop tube recess 252. The hoop tube 222 may also be pulled passed the locking nubs 256 to move the hoop tube 222 out of the hoop tube recess 252. The locking nubs 256 may be elastomer or rubber bodies with outward functional nub ends, a central narrow portion and rear flange ends that squeeze through smaller openings in the back panel 214 to trap the central narrow portion in the smaller opening with the rear flange end at a rear side of the back panel 214 and with the functional nub end directed toward the recess 252. In the alternative, the locking nubs 256 may be an integral part of the back panel 214 that slightly extend toward the recess 252 and are sufficiently resilient to allow the hoop tube 222 to pass by the locking nubs 256. Further, the locking feature may be provided by providing sufficient frictional resistance at the interface of the pivot axle 239 and the respective bushing 226, such that there is sufficient resistance to keep the hoop tube 222 in place within the recess 252. The sufficient frictional resistance at the interface of the pivot axle 239 and the respective bushing 226 is set to be not so much as to prevent the user from moving the hoop tube 222 out of the recess 252 and to the deployed position.

The rigid back panel 214 or hardshell (hard panel assembly) 214 supports storage features generally designated 260. The storage features 260 are particularly in the form of a plurality of support points 261 with nylon bands 262 for supporting various items. This may be in the form of a M.O.L.L.E.. Other pockets and support structures may also be provided attached to the hardshell 214.

The vehicle seat arrangement is shown in FIGS. 23A and 23B. The vehicle seats 202 with the backrest assembly 210 according to the invention cooperate with the front seats 4 and the rear storage space 206 of the vehicle 201. The one or more rearward seats 202 may be a part of a back row of seats disposed rearwardly of the front seats and possibly also rearwardly of intermediate seats (not shown). The backrest assembly 210 includes the backrest frame 240, comprised of a frame tube 242, as discussed above. The bracket frame tube 242 supports the hoop tube assembly 220 such that the pivotable hoop 222 may pivot between a stowed position, with the storage hoop extending along the backrest frame (FIG. 238A) to a hoop deployed position with the hoop extending rearwardly of the back panel 214 (FIG. 23B).

While specific embodiments of the invention have been shown and described in detail to illustrate the application of the principles of the invention, it will be understood that the invention may be embodied otherwise without departing from such principles.

What is claimed is:

1. A vehicle seat comprising:
a backrest;
a seat base connected to the backrest, at least one of the backrest and the seat base comprising a seat part frame, a trim side and an opposite harder side defining a planar surface with a recess having a recess contour;
fittings defining a seat base to backrest pivot connection, which is provided between the backrest and the seat base, for pivoting the seat base relative to the backrest or pivoting the backrest relative to the seat base;
pivotable hoop connections connected to the seat part frame; and
a storage hoop with hoop ends respectively connected to the respective pivotable hoop connections, the storage hoop being received in the recess to extend along the recess contour, whereby the storage hoop pivots between a stowed position, with the storage hoop extending along and within the recess, to a hoop deployed position, with the hoop extending outwardly from the opposite harder side defining the surface with the recess.

2. A vehicle seat according to claim 1, wherein said fittings defining the seat base to backrest pivot connection are configured for pivoting the seat base relative to the backrest between a seating position and a stadium flipped up position.

3. A vehicle seat according to claim 2, wherein the pivotable hoop connections have pivot locations that are respectively adjacent to the seat base to backrest pivot connections, such that in a pivoted out state the hoop extends outwardly and substantially horizontally from the seat base.

4. A vehicle seat according to claim 2, further comprising a cable assembly with a cable connected to one of the pivotable hoop connections wherein at least one of the seat base pivot connections has a latching cam connected to the cable of the cable assembly to lock the seat base in a position to prevent the seat base from pivoting relative to the backrest in the hoop deployed position.

5. A vehicle seat according to claim 4, wherein:
the seat part frame comprises a seat base frame, wherein said trim side comprises foam and trim connected to the seat base frame, and the opposite harder side comprises a hard panel assembly connected to the base frame;
the pivotable hoop connections comprise pivot brackets fixed to the base frame and brackets respectively fixed at the hoop ends and pivotably mounted to respective pivot brackets; and
the cable is connected to the pivotably mounted brackets to extend and retract in response to movement of the hoop between the stowed position and the deployed position.

6. A vehicle seat according to claim 5, wherein the storage hoop comprises a multi part construction comprising:
two side arms respectively extending from brackets to connection ends; and
an outer U-shaped hoop part with first and second U-shaped hoop ends respectively connected to the connection ends of the two side arms, wherein the outer U-shaped hoop part is mounted in the respective connection ends of side arms to telescopingly slide outwardly relative to the two side arms.

7. A vehicle seat according to claim 1, wherein the hoop has attachment features comprising additional hoop loops or hooks for adhering straps, bungees, ropes and other items inside and outside of the hoop.

8. A vehicle seat according to claim 2, wherein the opposite harder side comprises a hard panel assembly with straps supported relative to the opposite harder side to form a modular lightweight load-carrying equipment.

9. A vehicle seat according to claim 1, wherein said fittings defining the seat base to backrest pivot connection are configured for pivoting the backrest relative to the seat base between a seating position and a backrest folded down position.

10. A vehicle seat according to claim 9, wherein:
the seat part frame comprises a backrest frame structure, wherein said trim side comprises foam and trim connected to the backrest frame structure, and the opposite harder side comprises a hardshell panel connected to the backrest frame structure; and
the pivotable hoop connections comprise pivot brackets fixed to the backrest frame structure and brackets respectively fixed at the hoop ends and pivotably mounted to respective pivot brackets.

11. A vehicle seat according to claim 10, wherein the storage hoop comprises a multi part construction comprising:
two side arms respectively extending from brackets to connection ends; and
an outer U-shaped hoop part with first and second U-shaped hoop ends respectively connected to the connection ends of the two side arms, wherein the outer U-shaped hoop part is mounted in the respective connection ends of side arms to telescopingly slide outwardly relative to the two side arms.

12. A vehicle seat according to claim 9, wherein the hoop has attachment features comprising additional hoop loops or hooks for adhering straps, bungees, ropes and other items inside and outside of the hoop.

13. A vehicle seat according to claim 9, wherein the opposite harder side comprises a hard panel assembly with straps supported relative to the opposite harder side to form a modular lightweight load-carrying equipment.

14. A vehicle seat arrangement comprising:
front seats; and
at least one rear seat, disposed rearwardly of the front seats, the rear seat comprising:
a backrest;
a seat base connected to the backrest, at least one of the backrest and the seat base comprising a seat part frame, a trim side and an opposite harder side with a planar surface with a recess having a recess contour;
fittings defining a seat base to backrest pivot connection, which is provided between the backrest and the seat base, for pivoting the seat base relative to the backrest or pivoting the backrest relative to the seat base;
pivotable hoop connection connected to connected to the seat part frame; and
a storage hoop with hoop ends respectively connected to the respective pivotable hoop connections, the storage hoop being received in the recess to extend along the recess contour, whereby the storage hoop pivots between a stowed position, with the storage hoop extending along and within the recess, to a hoop deployed position, with the hoop extending outwardly from the opposite harder side.

15. A vehicle seat arrangement according to claim 14, wherein:
said fittings, defining the seat base to backrest pivot connection, are configured for pivoting the seat base relative to the backrest between a seating position and a stadium flipped up position; and
the pivotable hoop connections have pivot locations that are respectively adjacent to the seat base pivot connections, such that in a pivoted out state the hoop extends outwardly and substantially horizontally from the seat base.

16. A vehicle seat arrangement according to claim 15, further comprising a cable assembly with a cable connected to one of the pivotable hoop connections wherein:
at least one of the seat base pivot connections has a latching cam connected to the cable of the cable assembly to lock the seat base in a position to prevent the seat base from pivoting relative to the backrest in the hoop deployed position;
the seat part frame comprises a seat base frame structure, wherein said trim side comprises foam and trim connected to the seat base frame structure, and the opposite harder side comprises a hard panel assembly connected to the base frame structure;
the pivotable hoop connections comprise pivot brackets fixed to the seat base frame structure and brackets respectively fixed at the hoop ends and pivotably mounted to respective pivot brackets; and
the cable is connected to the pivotably mounted brackets to extend and retract in response to movement of the hoop between the stowed position and the deployed position.

17. A vehicle seat arrangement according to claim 16, wherein the storage hoop comprises a multi part construction comprising:
two side arms respectively extending from brackets to connection ends; and
an outer U-shaped hoop part with first and second U-shaped hoop ends respectively connected to the connection ends of the two side arms, wherein the outer U-shaped hoop part is mounted in the respective connection ends of side arms to telescopingly slide outwardly relative to the two side arms.

18. A vehicle seat arrangement according to claim 14, wherein:
said fittings defining the seat base to backrest pivot connection are configured for pivoting the backrest relative to the seat base between a seating position and a backrest folded down position;
the seat part frame comprises a backrest frame, wherein said trim side comprises foam and trim connected to the backrest frame, and the opposite harder side comprises a hardshell panel connected to the backrest frame; and
the pivotable hoop connections comprise pivot brackets fixed to the backrest frame and brackets respectively fixed at the hoop ends and pivotably mounted to respective pivot brackets.

19. A vehicle seat arrangement according to claim 18, wherein the storage hoop comprises a multi part construction comprising:
two side arms respectively extending from brackets to connection ends; and
an outer U-shaped hoop part with first and second U-shaped hoop ends respectively connected to the connection ends of the two side arms, wherein the outer U-shaped hoop part is mounted in the respective connection ends of side arms to telescopingly slide outwardly relative to the two side arms.

20. A vehicle seat arrangement according to claim 18, wherein the hoop has attachment features comprising additional hoop loops or hooks for adhering straps, bungees, ropes and other items inside and outside of the hoop.
